(19) United States
(12) Patent Application Publication
(10) Pub. No.: US 2009/0303525 A1
(43) Pub. Date: Dec. 10, 2009

(54) IMAGE FORMING APPARATUS THAT MANAGES CHARGING

(75) Inventor: Okihisa Yoshida, Amagasaki-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Chiyoda-ku (JP)

(21) Appl. No.: 12/345,690

(22) Filed: Dec. 30, 2008

(30) Foreign Application Priority Data
Jun. 6, 2008 (JP) 2008-149126

(51) Int. Cl. G06F 3/12

(52) U.S. Cl. 358/1.15

(57) ABSTRACT

An image forming apparatus analyzes a specified job to identify processing operations composing a process and a processing amount such as the number of copies and obtains unit prices set for the respective processing operations, from a charging map associated with a user who is an issuer of the job. By set documents being scanned, the number of documents are identified and charges are calculated based on the number of documents, the number of copies, and the obtained unit prices. The calculated charges are presented. When, at that stage, an instruction to perform the job is made, a copying process is performed. Then, after the copying process, charges are calculated based on the actual number of copies made and the unit prices.

This application is based on Japanese Patent Application No. 2008-149126 filed with the Japan Patent Office on Jun. 6, 2008, the entire content of which is hereby incorporated by reference.

### BACKGROUND OF THE INVENTION

1. Field of the Invention

The present invention relates to an image forming apparatus and a charging management method for the image forming apparatus. More particularly, the present invention relates to an image forming apparatus capable of performing charging management for each process of image formation and a charging management method for the image forming apparatus.

2. Description of the Related Art

Image forming apparatuses, such as copiers, printers, or MFPs (Multi-Function Peripherals) that are composite apparatuses thereof, may be installed and used in shops, etc. It is often the case that in the image forming apparatuses charges for copier use, etc., are calculated and collected.

Image forming apparatuses may be installed and used in offices. In the case also in which a company using image forming apparatuses branches into departments, such as a sales department and a general affairs department, and the image forming apparatuses are assigned respectively to the departments and the amounts of use thereof are managed by the respective departments, it is often the case that charges for copier use, etc., are calculated and counted.

Conventionally, such image forming apparatuses are not provided with many functions and thus only charging for a single type of process is performed. For example, in an image forming apparatus that is a copying machine, copy charges are calculated according to whether it is a color copy, paper size, etc. More specifically, Japanese Laid-Open Patent Publication No. 2005-284823 (hereinafter, Document 1) discloses, as an example of an image forming apparatus, a printing management apparatus that performs charging management of a printing apparatus. In the printing management apparatus disclosed in Document 1, charges according to the area of a printed region of print data are calculated.

For example, Japanese Laid-Open Patent Publication No. 11-355483 (hereinafter, Document 2) and Japanese Laid-Open Patent Publication No. 2000-341494 (hereinafter, Document 3) disclose, as an example of an image forming apparatus, a facsimile apparatus with a charging apparatus. In the image forming apparatus that is a facsimile apparatus disclosed in Documents 2 and 3, prior to facsimile transmission, balance information is obtained from the charging apparatus per page of document and charging management for facsimile transmission is performed using the information.

Nowadays, MFPs that are image forming apparatuses achieve greater functionality. For example, in addition to a function of printing image data obtained by scanning a document, some apparatuses may be provided with a function of directly transmitting the image data to another apparatus connected thereto or a function of reading out image data stored in another apparatus, such as a server, and directly transmitting the image data to still another specified apparatus. Also, in each process, the setting of a large variety of modes is enabled, such as a paper type mode such as paper size and thickness, a color mode such as color printing and monochrome printing, a print side mode such as single-sided printing and double-sided printing, a Nin1 mode representing the number of pages of documents arranged per paper, a post-processing mode such as stapling and folding processes, an instruction source mode indicating an apparatus by which an operation for specifying a job is performed, and a combination thereof.

Therefore, only with charging for a single type of process or charging for a single mode, as in conventional cases, appropriate charging may not be performed for the use of the image forming apparatus. For example, in the above-described example, assuming that the image forming apparatus performs only charging for a printing process, when a process of directly transmitting image data obtained by scanning a document to another apparatus or a process of reading out image data stored in another apparatus, such as a server, and directly transmitting the image data to still another specified apparatus is performed, there is a problem that charging is not performed for such a process.

### SUMMARY OF THE INVENTION

The present invention has been made in view of such a problem and an object of the present invention is therefore to provide an image forming apparatus capable of implementing charging management according to the contents of a job to be processed and a charging management method for the image forming apparatus.

To achieve the object, according to one aspect of the present invention, an image forming apparatus includes an accepting unit to accept a job; an analyzing unit to analyze the job to identify a plurality of processing operations composing a process for the job; a performing unit to perform the job, an obtaining unit to obtain unit prices set for the respective processing operations for the job; and a calculating unit to calculate charges for the process for the job by calculating charges for the respective processing operations for the job using the unit prices.

According to another aspect of the present invention, a charging management method for an image forming apparatus includes the steps of accepting, by the image forming apparatus, a job, analyzing the job to identify a plurality of processing operations composing a process for the job; obtaining unit prices set for the respective processing operations for the job; performing the job; and calculating charges for the process for the job by calculating charges for the respective processing operations for the job using the unit prices.

According to the present invention, an image forming apparatus can implement flexible charging management according to processing contents of a job to be processed.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing a specific example of a system configuration according to an embodiment.

FIG. 2 is a block diagram showing a specific example of a hardware configuration of an MFP (Multi-Function Peripheral) according to the embodiment.

FIG. 3 is a block diagram showing a specific example of a control configuration of the MFP according to the embodiment.

FIG. 4 is a diagram showing a specific example of a charging map.

FIG. 5 is a flowchart showing a specific example of a flow of a process performed by the MFP according to the embodiment.

FIG. 6 is a diagram describing processes performed by the MFP according to the embodiment and a server and a flow of the exchange of information therebetween.

FIG. 7 is a flowchart showing a specific example of a flow of a copy job process.

FIG. 8 is a diagram showing a specific example of a charging map.

### DESCRIPTION OF THE PREFERRED EMBODIMENTS

With reference to the drawings, an embodiment of the present invention will be described below In the following description, like parts and components are denoted by the same reference numerals and the names and functions thereof are also the same.

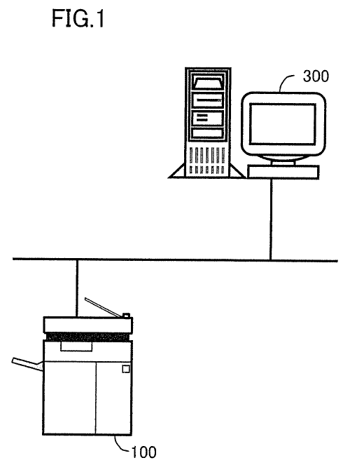

A system configuration according to the present embodiment is assumed to be a system configuration for an office environment, for example. With referent to FIG. 1, a system according to the present embodiment includes at least an MFP (Multi-Function Peripheral) 100 that is a specific example of an image forming apparatus; and a server 300 serving as a management apparatus. They are connected to each other by a wired or wireless communication line and thereby communicate with each other. Though not shown in FIG. 1, the system may include an information processing apparatus such as a personal computer.

The image forming apparatus according to the present invention is not limited to an MFP and can be any other apparatus as long as the apparatus has at least two or more types of functions for processing a job. MFP 100 according to the present embodiment has, as functions for processing a job, a scan function, a print function, a facsimile transmission function, and a post-processing function such as stapling and folding processes.

Server 300 is constructed by a general information processing apparatus such as a personal computer. Server 300 includes at least a storage apparatus such as an HDD (Hard Disk Drive); and a control apparatus including a CPU (Central Processing Unit). Furthermore, the control apparatus has a function of performing an authentication process using information stored in the storage apparatus and information transmitted from MFP 100. The authentication process performed by server 300 may be a commonly performed authentication process. Specifically, the authentication process performed by server 300 should be a process of returning MFP 100 the authentication result “authentication successful” when information stored in the storage apparatus matches information transmitted from MFP 100, and “authentication failure” when they do not match. Also, the control apparatus has a function of extracting information stored in the storage apparatus, using information transmitted from MFP 100.

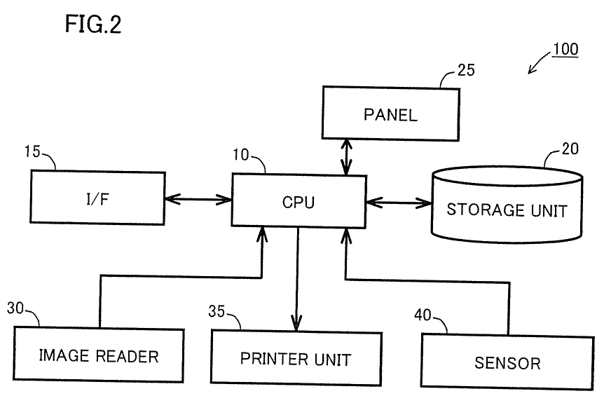

With reference to FIG. 2, MFP 100 includes a CPU 10 that controls the entire apparatus; an image reader 30 that reads a document and thereby obtains image data that is electronic data; a printer unit 35 that prints an image on paper; an interface (hereinafter, I/F) 15 for connecting MFP 100 to the above-described communication line or performing short distance wireless communication; a storage unit 20 composed of an HD (Hard Disk), etc., and storing, for example, document data, information on MFP 100, and a program to be executed by CPU 10; a panel 25 serving as means of displaying various information and also as instruction input means; and a sensor 40 that detects, for example, remaining amounts of consumables.

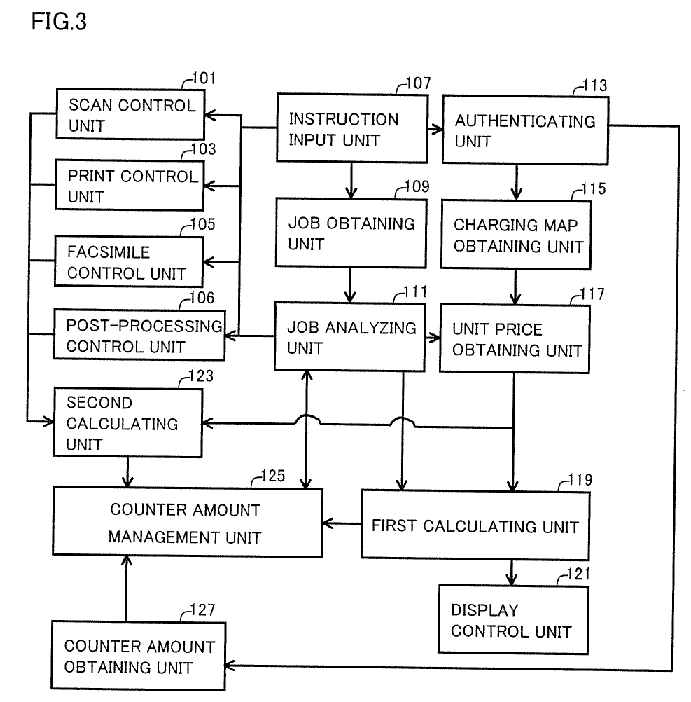

A control configuration of MFP 100 shown in FIG. 3 are control functions that are mainly formed in CPU 10 by CPU 10 reading out a program stored in storage unit 20 and executing the program. The hardware configuration shown in FIG. 2 may be included as part of the control configuration of MFP 100.

With reference to FIG. 3, the control configuration of MFP 100 includes a scan control unit 101 that controls a scanning process, a print control unit 103 that controls a printing process; a facsimile control unit 105 that controls a facsimile transmission process; a post-processing control unit 106 that controls post-processing, an instruction input unit 107 that accepts an input from panel 25; a job obtaining unit 109 that obtains a job; a job analyzing unit 111 that analyzes the obtained job; an authenticating unit 113 that transmits authentication information inputted from instruction input unit 107, to server 300 and obtains an authentication result, a charging map obtaining unit 115 that obtains a charging map, which will be described later, from server 300; a unit price obtaining unit 117 that obtains information indicating unit prices, which will be described later, from the obtained charging map; a first calculating unit 119; a display control unit 121 that generates a display signal for performing display on panel 25 and causes panel 25 to perform display; a second calculating unit 123; a counter amount obtaining unit 127 that obtains counter amount information, which will be described later, from server 300; and a counter amount management unit 125 that manages the obtained counter amount information.

Instruction input unit 107 accepts an input from panel 25. When MFP 100 is connected by wire or wirelessly to another apparatus, such as a personal computer, and thus can communication with the apparatus, instruction input unit 107 may accept an input from another apparatus through I/F 15. When the inputted information is authentication information, such as user information (e.g., a user name) or a password, for authenticating a user who is a job issuer, instruction input unit 107 inputs the authentication information to authenticating unit 113.

Authenticating unit 113 transmits the inputted authentication information to server 300 through I/F 15 and also requests server 300 to perform an authentication process. When server 300 is a device that manages MFP 100 by using service on the Web, the authentication information may be transmitted to server 300 in a data format represented by XML (Extensible Markup Language). Authenticating unit 113 receives an authentication result from server 300 through I/F 15. If authentication succeeds, then authenticating unit 113 inputs the user information to charging map obtaining unit 115 and counter amount obtaining unit 127.

When the accepted information is information instructing to perform a job, instruction input unit 107 inputs the inputted information to job obtaining unit 109. Also, instruction input unit 107 outputs, according to the inputted information, a control signal to scan control unit 101, print control unit 103, facsimile control unit 105, or post-processing control unit 106.

Job obtaining unit 109 obtains information identifying a job from the inputted information and inputs the information to job analyzing unit 111. The job indicates information including image data that is a processing target, specific processing contents, and a processing amount. Job analyzing unit 111 analyzes the inputted information to identify the above-described image data that is a processing target, specific processing contents, and processing amount that are included in the job. When specified image data is stored in a predetermined area of storage unit 20, job obtaining unit 109 accesses storage unit 20 to obtain the specified image data. Job analyzing unit 111 outputs a control signal to scan control unit 101, print control unit 103, facsimile control unit 105, or post-processing control unit 106, according to the identified processing contents and processing amount. At that time, job analyzing unit 111 refers to information, which will be described later, inputted from counter amount management unit 125. Furthermore, job analyzing unit 111 inputs information indicating the processing contents to unit price obtaining unit 117 and first calculating unit 119. Job analyzing unit 111 inputs information indicating the processing amount to first calculating unit 119.

Scan control unit 101, print control unit 103, facsimile control unit 105, or post-processing control unit 106 controls a process for a corresponding function, according to the control signal and inputs a processing result to second calculating unit 123.

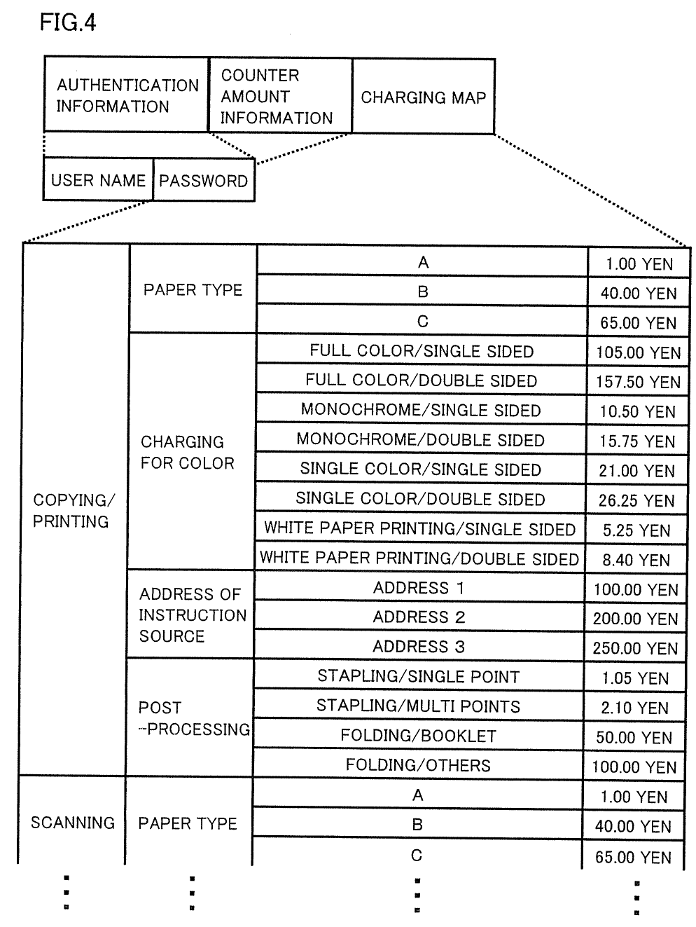

As shown in FIG. 4, server 300 stores, for each user, authentication information, counter amount information, and a charging map.

The charging map, a specific example of which is shown in FIG. 4, indicates information set for each user about unit prices (prices per sheet) for charges for respective items of processing modes corresponding to contents of a process performed on image data. Specifically, it is assumed that functions used in a process include a copy/print function, a scan function, etc. Each function includes several modes. For example, modes of the copy/print function include a paper type mode such as paper size and thickness; a color mode such as color printing and monochrome printing; a print side mode such as single-sided printing and double-sided printing; a Nin1 mode representing the number of pages of documents arranged per paper; a post-processing mode such as stapling and folding processes; and an instruction source mode indicating an apparatus (hereinafter, referred to as the “instruction source”) by which an operation for specifying a job is performed. Furthermore, each mode includes several items. One item corresponds to one step (processing operation) included in the process when a job is processed. For example, the paper type mode includes paper A as a first item, paper B as a second item, and paper C as a third item that identify paper according to the paper size, thickness, etc. The color mode includes full-color single-sided printing as a first item, full-color double-sided printing as a second item, monochrome single-sided printing as a third item, monochrome double-sided printing as a fourth item, single-color single-sided printing as a fifth item, single-color double-sided printing as a sixth item, single-sided printing on white paper as a seventh item, and double-sided printing on white paper as an eighth item. The instruction source mode includes address 1 as a first item, address 2 as a second item, and address 3 as a third item that identify the address of an instruction source. The post-processing mode includes a single-point stapling process as a first item, a multi-point stapling process as a second item, a folding process in a booklet form as a third item, and a folding process in other forms as a fourth item that identify post-processing. In the charging map, unit prices for charges are set for the above-described respective items.

The counter amount information indicates an upper limit of a process that is set for each user. Specifically, the counter amount information indicates the balance of charges (hereinafter, referred to as the remaining counter amount) at the present time before reaching the upper limit of charges allowed for the user in a predetermined period of time. The counter amount information may include, for example, types of process allowed for the user, e g., whether color printing is allowed and a range of facsimile destinations.

Additional description of the instruction source mode is provided. MFP 100 can store an address map in a predetermined area of storage unit 20. An address is information including 512 characters and is information identifying a device. The address map is information on IDs, each of which is identification information assigned to an address corresponding to a device. When a job is specified, MFP 100 obtains an ID indicating a specified apparatus, together with information specifying the job. Job analyzing unit 111 analyzes the job to identify the ID and further refers to the address map to identify a device corresponding to the identified ID. A processing mode of a job whose instruction source is a device stored in the address map is referred to as the instruction source mode.

FIG. 4 shows a specific example of the charging map in which charges per sheet are set as a unit price. However, for another example of the unit price, in the charging map, charges per unit file size may be set. In the charging map, charges per unit processing time may be set. In the charging map, a combination of these charges may be set.

Charging map obtaining unit 115 transmits, as a search key, the user information inputted from authenticating unit 113, to server 300 through I/F 15 and also requests server 300 to transmit a charging map and thereby obtains the charging map. The obtained charging map is inputted to unit price obtaining unit 117. Unit price obtaining unit 117 obtains set unit prices from the charging map, for the respective modes specified by the job, according to the processing contents inputted from job analyzing unit 111, and inputs the unit prices to first calculating unit 119 and second calculating unit 123.

Counter amount obtaining unit 127 transmits, as a search key, the user information inputted from authenticating unit 113, to server 300 through I/F 15 and also requests server 300 to transmit counter amount information and thereby obtains the counter amount information. The obtained counter amount information is inputted to counter amount information management unit 125.

First calculating unit 119 performs a charging calculation using the processing contents and processing amount inputted from job analyzing unit 111 and the unit prices inputted from unit price obtaining unit 117, and inputs a calculation result to display control unit 121 and counter amount management unit 125.

Second calculating unit 123 performs a charging calculation using a processing result of the job inputted from scan control unit 101, print control unit 103, facsimile control unit 105, or post-processing control unit 106 and the unit prices inputted from unit price obtaining unit 117, and inputs a calculation result to counter amount management unit 125.

Counter amount management unit 125 compares the calculation result inputted from first calculating unit 119 with a remaining counter amount indicated by the counter amount information. Counter amount management unit 125 inputs to job analyzing unit 111 information that is obtained as a result of the comparison and that indicates whether the process for the specified job can be performed within the remaining counter amount. Counter amount management unit 125 calculates a new remaining counter amount using the calculation result inputted from second calculating unit 123 and the remaining counter amount indicated by the counter amount information, and transmits the new remaining counter amount to server 300 through I/F 15.

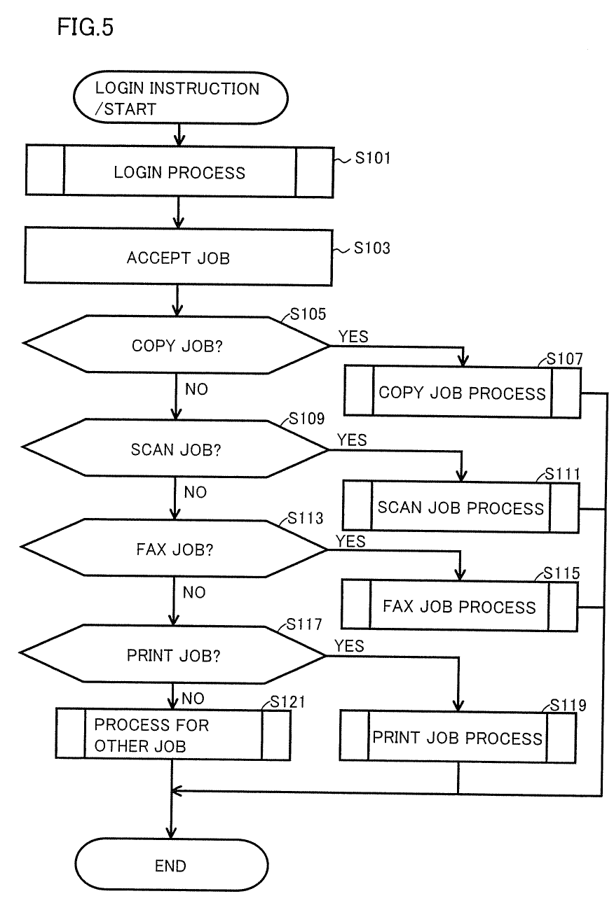

FIG. 5 is a flowchart showing a specific example of a flow of a process performed by MFP 100. The process shown in the flowchart of FIG. 5 starts when CPU 10 of MFP 100 accepts an input of an instruction signal to start login from panel 25 or the like. CPU 10 of MFP 100 reads out and executes a program stored in storage unit 20 in response to the instruction signal and each control unit shown in FIG. 3 performs control, whereby the process shown in the flowchart of FIG. 5 is implemented.

Referring to FIG. 5, after CPU 10 performs a login process in step S101, CPU 10 accepts, in step S103, a job according to an input of an instruction signal from panel 25 or the like. Job analyzing unit 111 analyzes the accepted job to identify a type of process for the job. If the type of process for the job is a copying process (YES in step S105), then MFP 100 performs a copy job process in step S107. If the type of process for the job is a scanning process (YES in step S109), then MFP 100 performs a scan job process in step S111 If the type of process for the job is a facsimile transmission process (YES in step S113), then MFP 100 performs a facsimile job process in step S115. If the type of process for the job is a printing process (YES in step S117), then MFP 100 performs a print job process in step S119. Note that if the type of process for the job is none of the above processes (NO in steps S105, S109, S113, and S117), then MFP 100 performs, in step S121, a process for the identified job other than the above.

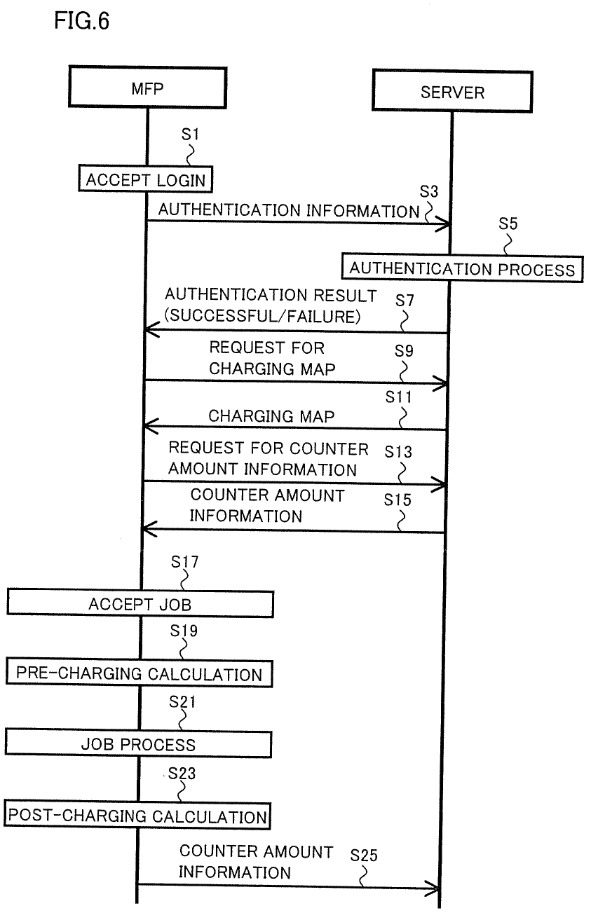

FIG. 6 is a diagram describing processes performed by MFP 100 and server 300 and a flow of the exchange of information therebetween.

Referring to FIG. 6, when MFP 100 accepts an operation for login from a user through panel 25 or the like (step S1), MFP 100 transmits inputted authentication information, such as user information and a password, to server 300 and requests server 300 to perform an authentication process (step S3).

In response to the request in step S3, server 300 performs, in an authenticating unit which is not shown, an authentication process using the authentication information transmitted in step S3 (step S5). Then, server 300 transmits information indicating an authentication result such as authentication successful or authentication failure, to MFP 100 (step S7).

If the authentication result transmitted in step S7 is authentication successful, then MFP 100 transmits the user information inputted in step S1, to server 300 and requests server 300 to transmit a charging map (step S9).

In response to the request in step S9, server 300 extracts a charging map associated with the transmitted user information, from a storage apparatus which is not shown, and transmits the charging map to MFP 100 (step S11).

MFP 100 transmits the user information inputted in step S1, to server 300 and requests server 300 to transmit counter amount information (step S13).

In response to the request in step S13, server 300 extracts counter amount information associated with the transmitted user information, from the storage apparatus which is not shown, and transmits the counter amount information to MFP 100 (step S15).

The process performed by MFP 100 in the above-described steps S1 to S15 corresponds to the login process in step S101. The processing order of the request for a charging map in step S9 and the request for counter amount information in step S13 is not limited to that shown in FIG. 6. A request to transmit a charging map and counter amount information if authentication has succeeded may be made at the same time as when a request for authentication is made in step S3.

When MFP 100 accepts an operation instructing a job from the user through panel 25 or the like (step S17), MFP 100 performs a charging calculation prior to the process for the job, using the charging map received in step S11 (step S19). Hereinafter, the charging calculation performed prior to the process for the job is referred to as the pre-charging calculation. Thereafter, a job process is performed (step S21) and a charging calculation is performed based on a result of the job process (step S23). Hereinafter, the charging calculation performed after the job is processed and based on a result of the process is referred to as the post-charging calculation. MFP 100 transmits counter amount information taking into account a result of the post-charging calculation in step S23, to server 300 (step S25).

The above-described process performed by MFP 100 in steps S19 to S25 corresponds to the job process in step S107, S111, S115, or S119.

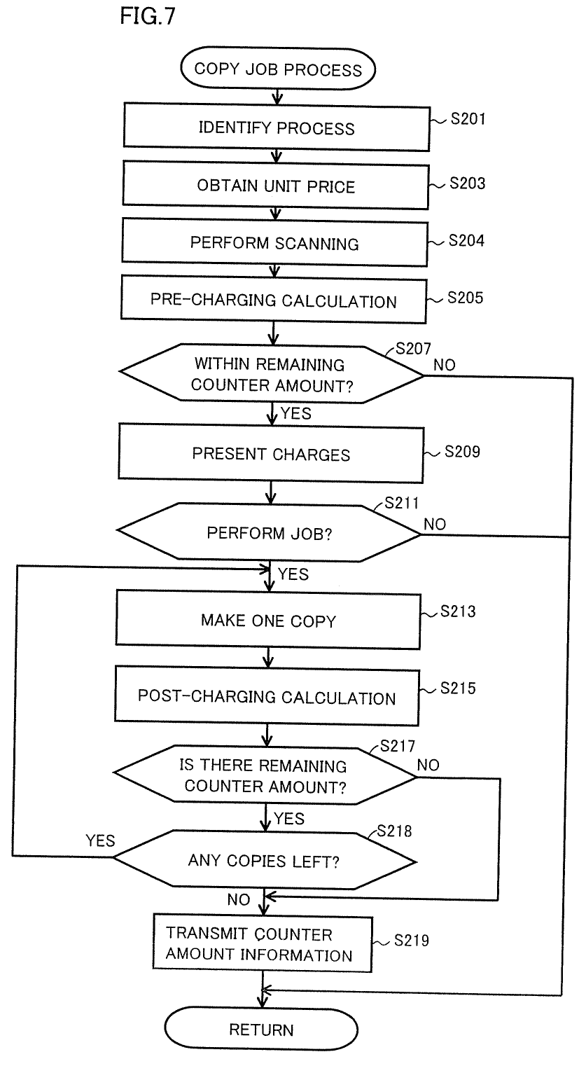

FIG. 7 is a flowchart showing a specific example of a flow of the copy job process in step S107 that is described as representative of the job processes in steps S107, S111, S115, and S119.

Referring to FIG. 7, in step S201, job analyzing unit 111 analyzes an accepted job to identify items of modes and a processing amount that are set in the job. The processing amount to be identified here is an amount set in the job, i.e., an amount identified from an operation instructing the job, and corresponds, for example, to the number of copies. In step S203, unit price obtaining unit 117 obtains unit prices set for the respective items identified in step S201, from the charging map obtained from server 300 in the login process in step SI 01 in the manner shown in steps S9 and S11.

In step S204, scan control unit 101 performs a scanning process according to a control signal from job analyzing unit 111, in which a document set on a document table, which is not shown, is scanned by image reader 30 to obtain image data. The image data obtained by scanning in step S204 is temporarily stored in a predetermined area of storage unit 20. Job analyzing unit 111 identifies a processing amount based on a scanning result in step S204. The processing amount to be identified is a processing amount obtained by performing a process on image data specified by the job. For example, the processing amount corresponds to the number of documents, the amount of data, the area of an image region, or the amount of toner to be calculated therefrom. When the copy job process is not a job in which a document is scanned and copied, but a job in which image data stored in storage unit 20, etc., is copied, job analyzing unit 111 identifies, in step S204, a processing amount by obtaining image data that is a processing target stored in storage unit 20, etc., and scanning the image data.

In step S205, first calculating unit 119 calculates charges for the case of performing all instructed processing operations, using the items of modes and processing amount identified in step S201, the unit prices for the respective items obtained in step S203, and the processing amount identified in step S204 (step S205).

Counter amount management unit 125 compares the charges calculated in step S205 with the counter amount information obtained from server 300 in the login process in step S101 in the manner shown in steps S13 and S15, to determine whether all the instructed processing operations can be performed within the remaining counter amount. If all the instructed processing operations can be performed within the remaining counter amount (YES in step S207), then in step S209, display control unit 121 displays the charges calculated in step S205 on panel 25 or the like. In step S209, when the instruction source of the job is another apparatus, information indicating the charges calculated in step S205 may be transmitted to this another apparatus.

In step S209, display control unit 121 preferably presents the charges calculated in step S205 and also presents instruction means serving as a configuration for performing an instruction to continue or cancel the process for the job. For example, when the charges are presented on panel 25, the instruction means corresponds, for example, to a button for instructing to continue the process and a button for instructing to cancel the process Note that the instruction means may further include a button for instructing to make a change to processing contents. When this instruction is accepted, the process is performed from step S201 again.

By performing, in step S205, a charging calculation prior to the job process and comparing, in step S207, the charges with the remaining counter amount, an event can be prevented from happening in which due to the remaining counter amount falling short during the process the job has to be interrupted. Note that in this example when it is determined as a result of a comparison made in advance with the remaining counter amount in step S207 that the process can be performed within the remaining counter amount, the charges calculated in step S205 are presented in step S209. However, even in the case in which the process cannot be performed within the remaining counter amount, the charges may be presented. Furthermore, in such a case, as described above, instruction means may be presented, such as a button for instructing to continue the process, a button for instructing to cancel the process, and a button for instructing to make a change to processing contents. By the calculation result being presented in step S209, the user can check the charges for the process prior to performing the process and thus an event can be prevented from happening in which the remaining counter amount falls short totally unexpectedly during the process and as a result the job is interrupted.

When continuing the process (YES in step S211), print control unit 103 performs a process according to a control signal from job analyzing unit 111, in which in step S213 one copy of the image data obtained by scanning in step S204 or the image data obtained from the predetermined area of the storage unit 20, etc, is printed by printer unit 35.

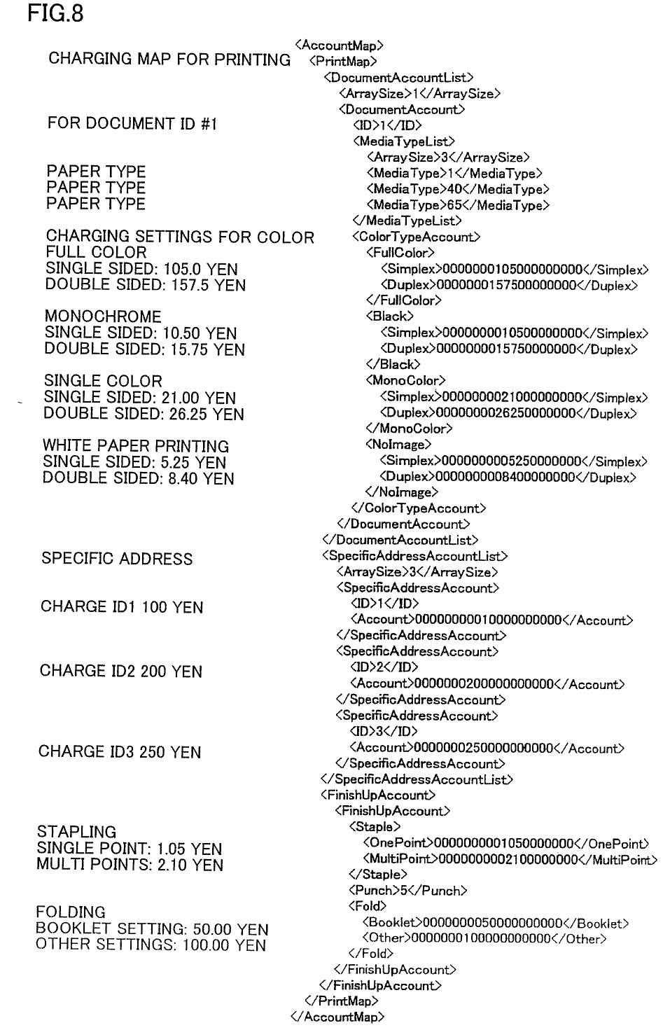

In step S215, second calculating unit 123 calculates charges for a process starting from the start of the job process to the process in step S213, using a processing result in step S213 and the unit prices obtained in step S203. Here, specifically, it is assumed that a charging map shown in FIG. 8 is obtained in step S203. The charging map in FIG. 8 shows one specific example for when the charging map described in FIG. 4 is handled by a computer, and shows a specific example of a charging map for a process using the print function. The charging map in a data format in FIG. 8 defines in the second line that this is a charging map for a process using the print function and defines in the sixth line that the document ID is “1”. In the seventh to twelfth lines, the unit prices for the respective items of the paper type mode are defined. Specifically, as shown in FIG. 4, as the unit price for the first item, the unit price for use of paper A is defined as 1 yen; as the unit price for the second item, the unit price for use of paper B is defined as 40 yen; and as the unit price for the third item, the unit price for use of paper C is defined as 65 yen. In the thirteenth to thirtieth lines, the unit prices for the respective items of the color mode are defined. Specifically, as shown in FIG. 4, in the fourteenth to seventeenth lines, as the unit price for the first item the unit price for full-color single-sided printing is defined as 105 yen, and as the unit price for the second item the unit price for full-color double-sided printing is defined as 157.5 yen, in the eighteenth to twenty-first lines, as the unit price for the third item the unit price for monochrome single-sided printing is defined as 10.5 yen, and as the unit price for the fourth item the unit price for monochrome double-sided printing is defined as 15.75 yen; in the twenty-second to twenty-fifth lines, as the unit price for the fifth item the unit price for single-color single-sided printing is defined as 21 yen, and as the unit price for the sixth item the unit price for single-color double-sided printing is defined as 26.25 yen; and in the twenty-sixth to twenty-ninth lines, as the unit price for the seventh item the unit price for single-sided printing on white paper is defined as 5.25 yen, and as the unit price for the eighth item the unit price for double-sided printing on white paper is defined as 8.4 yen. In the thirty-third to forty-seventh lines, the unit prices for the respective items of the instruction source mode are defined. Specifically, as shown in FIG. 4, in the thirty-fifth to thirty-eighth lines, as the unit price for the first item, the unit price for the instruction source being the address 1 is defined as 100 yen; in the thirty-ninth to forty-second lines, as the unit price for the second item, the unit price for the instruction source being the address 2 is defined as 200 yen; and in the forty-third to forty-sixth lines, as the unit price for the third item, the unit price for the instruction source being the address 3 is defined as 250 yen. In the forty-eighth to sixtieth lines, the unit prices for the respective items of the post-processing mode are defined. Specifically, as shown in FIG. 4, in the fiftieth to fifty-third lines, as the unit price for the first item the unit price for a single-point stapling process is defined as 1.05 yen, and as the unit price for the second item the unit price for a multi-point stapling process is defined as 2.1 yen, in the fifty-fourth line, as the unit price for an item, the unit price for a punching process is defined as 5 yen, and in the fifty-fifth to fifty-eighth lines, as the unit price for the third item the unit price for a folding process in a booklet form is defined as 50 yen, and as the unit price for the fourth item the unit price for a folding process in other forms is defined as 100 yen.

In step S213, with each item identified in step S201 being handled as one processing operation (step), several processing operations corresponding to the items identified in step S201 are performed and then the job is performed. At that time, scan control unit 101, print control unit 103, facsimile control unit 105, or post-processing control unit 106 measures actual processing amounts for the respective processing operations corresponding to the items identified in step S201, and inputs the processing amounts to second calculating unit 123. In step S215, second calculating unit 123 reads unit prices for the respective items identified in step S201 by sequentially scanning the charging map shown in FIG. 8 from the top and multiplies the inputted actual processing amounts by the unit prices and thereby calculates charges. Specifically, in step S215, by using unit prices that are minutely set for respective operations (steps) included in a process for performing one job, second calculating unit 123 multiplies the actual processing amounts of the respective operations by the unit prices and thereby calculates costs required for the actual process.

By MFP 100 performing the charging calculation in step S215, costs in conformity with the actual process are calculated. Specifically, for example, it is assumed that a stapling process is instructed in a copy job. However, in stapling specifications, there may be a limit on the number of sheets, e.g., up to 20 sheets. In this case, in spite of the above-described instruction, after copying, without performing a stapling process, printed paper is outputted. Even in this case, in the charging calculation in step S205, according to the instruction, costs for the case of performing a stapling process are calculated. However, the costs include a cost of a stapling process that is not actually performed. On the other hand, in the charging calculation in step S215, a charging calculation is performed according to the actual process of operations. Therefore, when, after calculating costs of a process up to a copying process, a stapling process is not performed, even if an instruction includes the process, a cost of a stapling process is not calculated. Accordingly, even when a process different from that instructed is actually performed, costs according to the process actually performed are charged without any unnecessary cost being charged.

Counter amount management unit 125 subtracts the charges calculated in step S215 from the remaining counter amount indicated by the counter amount information and determines whether there is still a remaining counter amount. If there is still a remaining counter amount (YES in step S217) and making a number of copies that is the processing amount identified in step S201 has not yet been completed (YES in step S218), then the processes in steps S213 and S215 are repeated. If making the instructed number of copies has been completed (NO in step S218), then in step S219, counter amount management unit 125 transmits to server 300 counter amount information obtained by subtracting charges calculated in the latest step S215 from the remaining counter amount indicated by the counter amount information. If the remaining counter amount reaches zero before making the instructed number of copies has been completed (NO in step S217), then without performing subsequent copying, counter amount management unit 125 transmits, in step S219, counter amount information up to that point in time to server 300.

By performing the above-described process, MFP 100 can implement flexible charging using unit prices that are set for the respective items of modes, as shown in FIG. 4. Along with the achievement of greater functionality by an image forming apparatus such as an MFP, processing operations diversify and thus it is likely that in response to user needs, the number of items corresponding to the above-described processing operations that can be set by one type of process increases. Even in such a case, MFP 100 can obtain unit prices for respective items set in an instructed process and calculate charges for performing the instructed process, using the unit prices. Accordingly, appropriate charging in conformity with an actual process can be implemented.

In the above-described example, calculation of charges is performed at two stages first, at a stage prior to the start of a copying process, first calculating unit 119 calculates charges based on instructed contents (pre-charging calculation), and then, after the copying process, second calculating unit 123 calculates charges based on a processing result (post-charging calculation).

To implement appropriate charging, MFP 100 calculates by second calculating unit 123 at least charges based on a processing result, i.e., performs at least calculation of charges at the second stage.

For example, even when a job is instructed, MFP 100 may not perform a process according to processing operations as instructed. Specifically, even when a stapling process is instructed as post-processing, if there are no staples left or, as in the above-described case, the printed paper is thicker than a thickness allowed for a stapling process, a stapling process is not performed. In MFP 100, by performing the above-described calculation of charges at the second stage, charging for processing operations that are actually performed is implemented. That is, appropriate charging is implemented according to the process.

However, since the unit prices set for the respective items are used, there may be a case in which the user does not know what are the charges at the point when instructing a job. Particularly, when MFP 100 achieves higher functionality and accordingly the number of items that can be set by one type of process increases, it becomes difficult for the user to grasp charges before processing a job. Therefore, an event is likely to occur in which when charging is performed after a process and based on a processing result, the user finds out only after the process is done that high charges that are not intended by the user are incurred.

In view of the above, MFP 100 calculates, by first calculating unit 119, charges based on instructed contents at a stage prior to the start of a copying process, i.e., performs the above-described calculation of charges at the first stage By performing this process, when, for example, performing copying, at the point in time when a document is scanned or when image data that is a copy target is read out from a storage apparatus and scanned, charges are calculated based on instructed modes and unit prices set in a charging map for the respective modes (pre-charging calculation) and the calculated charges are presented. Thus, the user can know what are approximate charges as a rough idea before a process is performed and accordingly a problem, such as that described above, can be overcome.

Furthermore, as described above, prior to the start of a process, the above-described rough idea of charges is presented and also means of instructing to cancel the process and means of instructing to make a change to processing contents are presented, whereby user convenience can be improved. For example, when the presented charges are higher than intended charges, the process can be changed to one with lower unit prices or the process can be cancelled. Alternatively, for example, when the presented charges are lower than intended charges, the process can be changed to one with higher unit prices or a processing operation setting can be added.

In the above-described process, if it is determined prior to the start of a process for a job that it is not possible to perform all instructed processing operations within the remaining counter amount (NO in step S207) or if the remaining counter amount reaches zero in the process of making the instructed number of copies (NO in step S217), then the above-described copy job process ends. However, if the process is not performed or interrupted when the remaining counter amount is short, user convenience may be deteriorated.

In view of the above, for example, if it is determined prior to the start of a process for a job that it is not possible to perform all instructed processing operations within the remaining counter amount (NO in step S207), counter amount obtaining unit 127 may request server 300 to increase the counter amount. Alternatively, only those of the instructed processing operations that can be done within the remaining counter amount may be performed. Alternatively, as previously described, means of instructing to make a change to processing contents may be presented on panel 25 or the like, to accept a change to the processing contents The same operation can also be performed when the remaining counter amount reaches zero in the process of making the instructed number of copies (NO in step S217) By doing so, deterioration of user convenience is avoided.

In the above-described example, as a process for a job, a process for the case in which the type of process for a job is a copying process is described as an example. Even when the type of process for a job is other types of process, e.g., a facsimile transmission process or a scanning process, the same process as that described using FIG. 7 is performed except for a specific process.

Although, in the above-described example, a charging counter amount is associated with a user, the same charging counter amount may be used for all users. In that case, the need for an authentication process can be eliminated. Alternatively, a charging counter amount may be associated with a specific group (e.g., a department or section) to which a user belongs.

MFP 100 may have all functions of server 300 or any or all of the functions of MFP 100 other than scan control unit 101, print control unit 103, facsimile control unit 105, and post-processing control unit 106 may be included in server 300. That is, the distribution of configurations and the distribution of functions between MFP 100 and server 300 are not limited to those described in the above example A system configuration may include an apparatus(es) other than MFP 100 and server 300 and configurations and functions may be distributed among MFP 100, server 300, and the other apparatus(es).

A program for causing an image forming apparatus such as MFP 100 to perform a process for a job including the above-described charging calculations can also be provided Such a program can also be provided in the form of a program product by being recorded in a computer-readable recording medium such as a flexible disk, CD-ROM (Compact Disk-Read Only Memory), ROM (Read Only Memory), RAM (Random Access Memory), or memory card. Alternatively, the program can also be provided by being recorded in a recording medium that is built in a device, such as a hard disk. Alternatively, the program can also be provided by download through a network.

The program according to the present invention may invoke a necessary module among program modules that are provided as part of an operating system (OS) of a computer, in a predetermined order and at predetermined timing to cause the computer to perform a process. In that case, the program itself does not include the above-described modules and thus a process is performed in cooperation with the OS. Such a program that does not include modules can also be encompassed in the program according to the present invention.

The program according to the present invention may be provided by being included as part of another program. In that case, too, the program itself does not include modules included in the above-described another program and thus a process is performed in cooperation with the above-described another program. Such a program included in another program can also be encompassed in the program according to the present invention.

The program product to be provided is installed in a program storage unit of, for example, a hard disk and executed. Note that the program product includes a program itself and a recording medium having recorded therein the program.

Although the present invention has been described and illustrated in detail, it is clearly understood that the same is by way of illustration and example only and is not to be taken by way of limitation, the scope of the present invention being interpreted by the terms of the appended claims.

What is claimed is:

1. An image forming apparatus comprising:
an accepting unit to accept a job;
an analyzing unit to analyze said job to identify a plurality of processing operations composing a process for said job;
a performing unit to perform said job;
an obtaining unit to obtain unit prices set for said respective processing operations for said job; and
a calculating unit to calculate charges for said process for said job by calculating charges for said respective processing operations for said job using said unit prices.

2. The image forming apparatus according to claim 1, wherein said calculating unit includes a first calculating unit to calculate charges for said process for said job by calculating charges for each of those of said plurality of processing operations identified by said analyzing unit that have been performed by said performing unit

3. The image forming apparatus according to claim 1, wherein
said analyzing unit analyzes said job to identify processing amounts of said respective processing operations for said job,
said calculating unit includes a second calculating unit to calculate, for each of said plurality of processing operations identified by said analyzing unit, charges for said process for said job for a case of performing said processing operations with said amounts analyzed by said analyzing unit, before said performing unit performs said job, and
said image forming apparatus further comprises a presenting unit to present said charges calculated by said second calculating unit.

4. The image forming apparatus according to claim 3, wherein
said presenting unit further presents an instructing unit to instruct to perform said job, and
said performing unit performs said job when an instruction to perform said job is made by said instructing unit.

5. The image forming apparatus according to claim 3, further comprising:
a reading unit to read a document and thereby obtain image data, wherein
said analyzing unit analyzes said job created based on said image data, to identify processing amounts of said respective processing operations for said job.

6. The image forming apparatus according to claim 1, wherein
said unit prices are set in association with an issuer of said job,
said image forming apparatus further comprises:
an input unit to input authentication information on said issuer of said job; and
an authenticating unit to obtain an authentication result using said authentication information, and
when said authentication result is authentication successful, said obtaining unit obtains said unit prices set in association with said issuer of said job.

7. A charging management method for an image forming apparatus, comprising the steps of:
accepting, by said image forming apparatus, a job,
analyzing said job to identify a plurality of processing operations composing a process for said job;
obtaining unit prices set for said respective processing operations for said job, performing said job; and
calculating charges for said process for said job by calculating charges for said respective processing operations for said job using said unit prices.

8. The charging management method according to claim 7, wherein said step of calculating charges for said process for said job includes a step of calculating charges for said process for said job by calculating charges for each of those of said plurality of processing operations identified in said step of analyzing said job that have been performed in said step of performing said job.

9. The charging management method according to claim 7, wherein
in said step of analyzing said job, said job is analyzed to identify processing amounts of said respective processing operations for said job,
said step of calculating charges for said process for said job includes a step of calculating, for each of said plurality of processing operations identified in said step of analyzing said job, charges for said process for said job for a case of performing said processing operations with said amounts analyzed in said step of analyzing said job, before said job is performed in said step of performing said job, and
said charging management method further comprises a step of presenting said charges calculated in said step of calculating charges for said process for said job before said job is performed.

10. The charging management method according to claim 9, wherein
in said step of presenting said charges, an instructing unit to instruct to perform said job is further presented on said image forming apparatus, and
in said step of performing said job, said job is performed when an instruction to perform said job is made by said instructing unit.

11. The charging management method according to claim 9, further comprising a step of reading a document and thereby obtaining image data, wherein
in said step of analyzing said job, said job created based on said image data is analyzed to identify processing amounts of said respective processing operations for said job.

12. The charging management method according to claim 7, wherein
said unit prices are set in association with an issuer of said job,
said charging management method further comprises the steps of:
inputting authentication information on said issuer of said job; and
obtaining an authentication result using said authentication information, and
when said authentication result is authentication successful, in said step of obtaining said unit prices, said unit prices set in association with said issuer of said job are obtained.

13. A computer-readable recording medium having recorded therein a program for causing a computer connected to an image forming apparatus to perform a process for managing charging incurred with a process performed by said image forming apparatus, said program causing said computer to perform the steps of:
analyzing a job accepted by said image forming apparatus to identify a plurality of processing operations composing a process for said job;
obtaining unit prices set for said respective processing operations for said job,
causing said image forming apparatus to perform said job; and
calculating charges for said process performed by said image forming apparatus for said job by calculating charges for said respective processing operations for said job using said unit prices.

14. The recording medium according to claim 13, wherein said step of calculating charges for said process for said job includes a step of calculating charges for said process performed by said imaging forming apparatus for said job by calculating charges for each of those of said plurality of processing operations identified in said step of analyzing said job that have been performed by said image forming apparatus in said step of performing said job.

15. The recording medium according to claim 13, wherein
in said step of analyzing said job, said job is analyzed to identify processing amounts of said respective processing operations for said job,
said step of calculating charges for said process performed by said image forming apparatus for said job includes a step of calculating, for each of said plurality of processing operations identified in said step of analyzing said job, charges for said process for said job for a case of performing said processing operations with said amounts analyzed in said step of analyzing said job, before said image forming apparatus is caused to perform said job in said step of performing said job, and
said program further causes said computer to perform a step of presenting said charges calculated in said step of calculating charges for said process performed by said image forming apparatus for said job before said image forming apparatus is caused to perform said job.

16. The recording medium according to claim 15, wherein
in said step of presenting said charges, an instructing unit to instruct to perform said job is further presented on said image forming apparatus, and
in said step of performing said job, said image forming apparatus is caused to perform said job when an instruction to perform said job is made by said instructing unit.

17. The recording medium according to claim 15, wherein
said program further causes said computer to perform a step of causing said image forming apparatus to read a document and thereby obtain image data, wherein
in said step of analyzing said job, said job created based on said image data is analyzed to identify processing amounts of said respective processing operations for said job.

18. The recording medium according to claim 13, wherein
said unit prices are set in association with an issuer of said job,
said program further causes said computer to perform the steps of:
inputting authentication information on said issuer of said job; and
obtaining an authentication result using said authentication information, and
when said authentication result is authentication successful, in said step of obtaining said unit prices, said unit prices set in association with said issuer of said job are obtained.
